(19) United States
(12) Patent Application Publication
(10) Pub. No.: US 2011/0021860 A1
(43) Pub. Date: Jan. 27, 2011

(54) Remediation of polychlorinated biphenyls in retired natural gas distribution systems

(76) Inventor: David B. Crook, Wonder Lake, IL (US)

Correspondence Address: Olson & Cepuritis, LTD., 20 NORTH WACKER DRIVE, 36TH FLOOR, CHICAGO, IL, 60606, US

(21) Appl. No.: 12/589,747

(22) Filed: Oct. 28, 2009

Related U.S. Application Data
(60) Provisional application No. 61/271,461, filed on Jul. 21, 2009.

(51) Int. Cl. B09B 3/00

(52) U.S. Cl. 588/255

(57) ABSTRACT

Retired natural gas pipeline portions are filled with polyurethane foam compositions sealing therewithin any polychlorinated biphenyls (PCBs) that may be present in the retired pipeline portion.

### CROSS-REFERENCE TO RELATED APPLICATIONS

This application claims the benefit of U.S. Provisional Application No. 61/271,461, filed Jul. 21, 2009, which is incorporated herein by reference.

### FIELD OF THE INVENTION

This invention relates to remediation of polychlorinated biphenyl contaminated natural gas pipelines.

### BACKGROUND OF THE INVENTION

Polychlorinated biphenyls (PCBs) are a blend of liquid compounds used in a variety of industrial products because of their thermal and chemical stability. In natural gas transmission and distribution systems, PCBs have been used as a compressor lubricant and valve sealant. In such uses the PCBs come in contact with the gas that is transmitted, enter the gas stream, become distributed throughout the transmission system, and adhere to the piping.

PCBs are known to present a risk to human health, thus containment of PCBs present in natural gas pipelines that are being retired from service is necessary.

The present invention presents a cost-effective solution for containing PCBs present in natural gas pipelines that are to be removed from service.

### SUMMARY OF THE INVENTION

Polychlorinated biphenyl compounds present in natural gas pipelines can be effectively contained therewithin when segments or portions of such pipelines are retired from service by introducing a polyurethane foam into the pipeline segment prior to its removal from the natural gas transmission system. Closed cell, hydrophobic as well as hydrophilic polyurethane foams are eminently well suited for this purpose and can be readily introduced into a pipeline segment by injection using commercially available injection equipment.

### BRIEF DESCRIPTION OF THE DRAWINGS

In the drawing,

FIG. 1 is a schematic illustration of a retired natural gas pipeline portion sealed with polyurethane foam.

### DESCRIPTION OF PREFERRED EMBODIMENTS

Polyurethane foam compositions, including polyurethane-based grouts, suitable for the purposes of the present invention are commercially available. These polyurethane compositions are designed to react with water and expand in place forming a tight seal with the natural gas pipe segment or portion, and trapping any PCBs present in the cells of the foam. After injection into the pipe segment, the polyurethane component reacts with water to form an expanding foam that fills the pipe. After expansion, the final product is a closed cell polyurethane foam that can be rigid or flexible, depending on the reactants utilized. The polyurethane foam can be hydrophobic or hydrophilic, again depending on the reactants utilized.

The gas pipeline segments to be retired can contain water. Inasmuch as hydrophilic polyurethane foams tend to shrink when the absorbed water dries up or evaporates, hydrophobic polyurethane foams are preferred for the present purposes because of their dimensional stability with or without the presence of water as well as cost considerations. Also, hydrophobic polyurethane foams expand more in volume.

Hydrophobic polyurethanes are made from isocyanate bases such as tolulene diisocyanate and methylene diisocyanate. A methylene diisocyanate (MDI) base is generally considered to constitute a less hazardous material and thus may be preferred. The hydrophobic polyurethane foam shown in U.S. Pat. No. 6,747,068 is suitable for use in the present invention. Other suitable hydrophobic polyurethanes include Prime-Flex 910 and Prime-Flex 920 supplied by Prime Resins, Inc., Conyers, Ga.; AV-248 Flexseal, AV-275 Soilgrout, and AV-280 Hydrofoam supplied by Avanti International, Webster, Tex.; and Flexible, SLV, HL-100, and Ultra supplied by Green Mountain International, LLC, Waynesville, N.C.

The foamable polyurethane compositions or grouts based on such compositions are introduced into the retired pipeline segments by pumping into an injection port for the segment. An existing service access port can be utilized, or a new injection port can be made at a conveniently accessible location. Pumping (injection) pressures can vary, depending on the diameter and length of the pipe, but usually are in the range of about 250 to 3,000 pounds per square inch (psi), preferably about 2,000 psi.

If necessary, a vent can be provided spaced from the injection port in any convenient manner.

Water-reactive single component polyurethane foam compositions are preferred; however, two-component, non-water-reactive polyurethane grouts can be utilized as well.

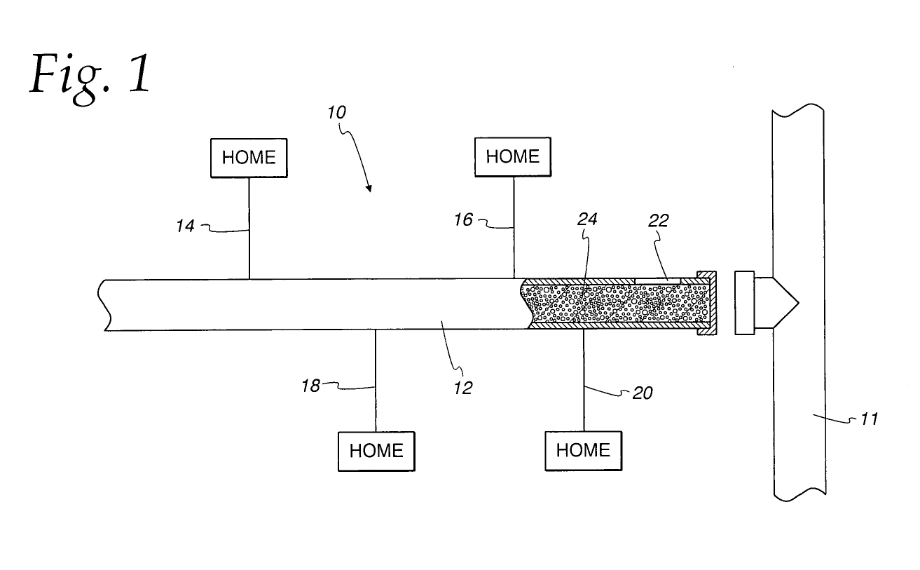

FIG. 1 illustrates an embodiment of the present invention. A natural gas distribution system 10 includes an operational natural gas pipeline 11 and a retired portion thereof constituted by main conduit 12 and individual service conduits 14, 16, 18 and 20. Retired main conduit 12 is filled with polyurethane foam 24 through injection port 22. A vent for main conduit 12 can be provided through any one of the individual service conduits 14, 16, 18 or 20 as the injected polyurethane foams and expands into conduit 12, substantially filling the interior volume of conduit 12 and encapsulating within the resulting foam cells any PCBs present in the conduit, and effectively sealing the conduit for environmentally safe removal of the retired main conduit segment by segment.

The foregoing description and the drawing are illustrative and are not to be taken as limiting the present invention. Still other variations within the spirit and scope of the present invention are possible and will readily present themselves to those skilled in the art.

I claim:

1. A method of sealing a retired natural gas pipeline segment which comprises the steps of providing an injection port in the retired segment and introducing into the retired segment a foamable polyurethane composition through said injection port.

2. The method in accordance with claim 1 wherein a vent is provided in the segment spaced from the injection port.

3. The method in accordance with claim 1 wherein the polyurethane composition produces a hydrophobic foam.

4. The method in accordance with claim 1 wherein the polyurethane composition produces a hydrophilic foam.

5. A method for remediating environmental pollution by polychlorinated biphenyl compounds which comprises the step of sealing a natural gas pipeline no longer in service but containing polychlorinated biphenyl compounds with a polyurethane foam composition.

6. A natural gas supply pipe segment substantially filled with polyurethane foam composition.
